(19) United States
(12) Patent Application Publication
(10) Pub. No.: US 2006/0055893 A1
(43) Pub. Date: Mar. 16, 2006

(54) Method and apparatus for monitoring signals of a projector

(75) Inventors: Chih-Neng Tseng, Miao-Li (TW); Chih-Nan Wu, Miao-Li (TW); Jain-Chung Huang, Miao-Li (TW); Ching-Kao Pan, Miao-Li (TW)

Correspondence Address: BACON & THOMAS, PLLC, 625 SLATERS LANE, FOURTH FLOOR, ALEXANDRIA, VA, 22314, US

(73) Assignee: Coretronic Corporation, Miao-Li (TW)

(21) Appl. No.: 11/183,798

(22) Filed: Jul. 19, 2005

(30) Foreign Application Priority Data
Sep. 10, 2004 (TW) 093127614

(51) Int. Cl. G03B 21/20

(52) U.S. Cl. 353/85

(57) ABSTRACT

A method and apparatus for monitoring signals of a projector includes a power supply, a signal-processing unit, a control unit, a starter and a lamp. The power supply provides the power, and then the signal-processing unit transmits the starting signal to the starter. The control unit monitors and determines if the signal is normal, and then controls the power supply and the signal-processing unit according to the signal. Therefore, the present invention can prevent the lamp from bursting, increase the safety of the users, and raises the stability of the projector.

### FIELD OF THE INVENTION

The present invention relates to a projector, and more particularly, relates to a method and apparatus for monitoring signals of a projector.

### BACKGROUND OF THE INVENTION

Please refer to FIG. 1. The starting system of a conventional projector 10 includes a signal-processing unit 11, a starter 12 and a lamp 13. A power supply is used to provide the power for the projector 10. Signals are transmitted to the starter 12 by the electrical connection of the signal-processing unit 11 and the starter 12. The signals include the starting signal and the periodical pulse wave. At first, the signal-processing unit 11 transmits the starting signal to the starter 12. Then, the starter 12 outputs electricity of a high voltage to drive the lamp 13. According to the controller 121 disposed inside the starter 12, it can be determined that whether the lamp 13 is started or not. When it is confirmed that the lamp 13 is started, the starter 12 transmits the “on” signal to the signal-processing unit 11. Then the signal-processing unit 11 transmits the periodical pulse wave to the starter 12. However, sometimes the lamp 13 can not be started successfully because of the signal error caused by the following reasons, for example: the solder point of the electrical component is not well-formed and consequently the circuit opens, then causes the failure of starting the lamp 13, at this time, there is no output signal from the signal-processing unit 11. Or the high voltage when starting the lamp causes the pulse wave, noise or electrical magnetic interference (EMI), and causes the dying out of the lamp 13, the destruction of the other electrical components, and the explosion of the lamp 13. Moreover, the transient high voltage when starting the lamp causes the output waveform of the signal-processing unit 11 to become a pulse wave. Not only the mentioned error of the electrical signals impacts on the stability of the operation of the projector, but also the scattered pieces of the lamp 13 caused by the explosion become dangerous to the users.

Since the conventional projector 10 lacks the method and apparatus for monitoring signals, it cannot execute any process to protect the projector 10 in case there is any error of the electrical signals. Nowadays, how to monitor the signals simultaneously in order to raise the users' safety and improve the stability of the projector 10 has become a topic of researching by the manufacturers in the related fields.

### SUMMARY OF THE INVENTION

One object of the present invention is to provide a method and apparatus for monitoring signals of a projector by taking advantage of the control unit to monitor and determine if the signal is normal, and control the power supply according to the signal in order to prevent the lamp from bursting, to increase the safety of the users and raise the stability of the projector.

Another object of the present invention is to provide a method and apparatus for monitoring signals of a projector by taking advantage of monitoring and determining the signals in order to raise the stability of the projector.

Still another object of the present invention is to provide a method and apparatus for monitoring signals of a projector by taking advantage of the status display apparatus in order to display the real-time and updated operating status.

In order to achieve the above objects, a method and apparatus for monitoring signals of a projector comprises a power supply, a signal-processing unit, a control unit, a starter and a lamp. The power supply provides the power, and the signal-processing unit transmits the starting signal to the starter. The control unit monitors and determines if the signal is normal, and controls the power supply and the signal-processing unit according to the signal. Therefore, the present invention can prevent the lamp from bursting, increase the safety of the users and raise the stability of the projector.

### BRIEF DESCRIPTION OF THE DRAWINGS

Other features and advantages of the present invention will become apparent in the following detailed description of the preferred embodiment with reference to the accompanying drawings, in which:

FIG. 1 is a schematic view of the components of a conventional projector.

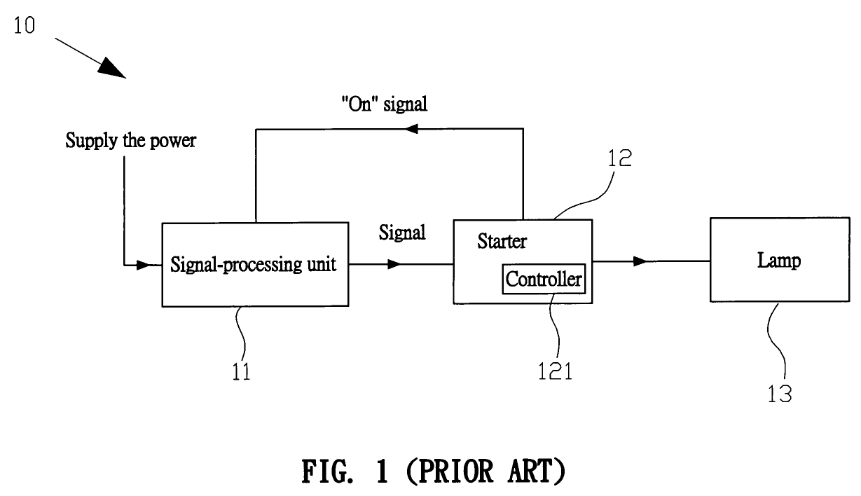

FIG. 2 is a schematic view of the components of the projector in one preferred embodiment of the present invention.

FIG. 3 is the flow chart of the control method of the projector in the preferred embodiment of the present invention.

### DETAILED DESCRIPTION OF THE PREFERRED EMBODIMENT

To make it easier for our examiners to understand the objects of the present invention, its structure, innovative features, and performance, we use a preferred embodiment together with the attached drawings for the detailed description of the invention.

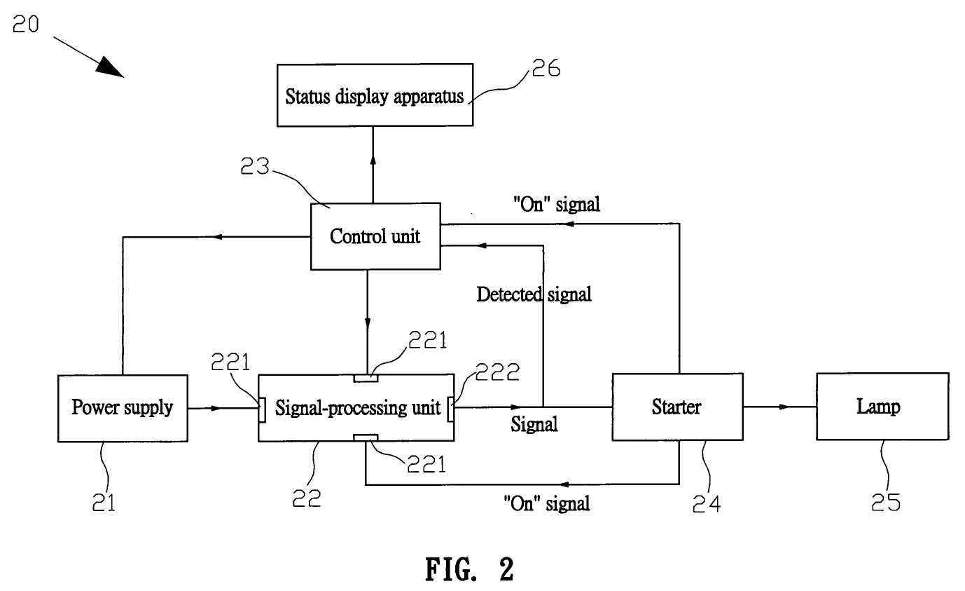

Please refer to FIG. 2; the projector 20 of the present invention includes a power supply 21, a signal-processing unit 22, a control unit 23, a starter 24, and a status display apparatus 26. The power supply 21 is used to supply the power needed by the projector 20. The signal-processing unit 22 includes signal input ports 221 and a signal output port 222. The signal input ports 221 are connected to the control unit 23, the power supply 21 and the starter 24. The control unit 23 includes a microcontroller (not shown in this figure), and the signal output port 222 is connected to the starter 24 in order to transmit signals to the starter 24 to drive and start the lamp 25. The signals include the starting signal and the periodic pulse wave. The control unit 23 is connected to the power supply 21, the signal-processing unit 22 and the signal output port 222 of the signal-processing unit 22 in order to control the power supply 21 and monitor the signals provided by the signal-processing unit 22. The control unit 23 is connected to the signal output port 222 of the signal-processing unit 22 in order to transmit the real-time detected signals to the control unit 23. The control unit 23 monitors the status of the signals by the detected signals, and the detected signals include a first detected signal and a second detected signal. The starter 24 is connected to the lamp 25 and outputs electricity of a high voltage in order to drive the lamp 25. By taking advantage of the controller (not shown in this figure) disposed inside the starter 24, it is determined if the lamp is started or not. When it is confirmed that the lamp 25 is started, the starter 25 transmits the “on” signal to the control unit 23 and the signal-processing unit 22. The status display apparatus 26 is disposed on the housing of the projector 20 and is connected to the control unit 23 in order to display the real-time operating status (including the error message) of the projector 20 onto a liquid crystal display panel or by a light emitting diode (LED) in order to provide the information of the error signals to the users. The present invention takes advantage of the control unit 23 in order to monitor the signals, and to control the power supply 21, the signal-processing unit 22, and the status display apparatus 26 by the monitored signals, and consequently it raises the stability of the projector 20. Moreover, the projector of the present invention takes advantage of the display apparatus 26 in order to show the real-time and updated operating status (including the error message) of the projector 20 to the users.

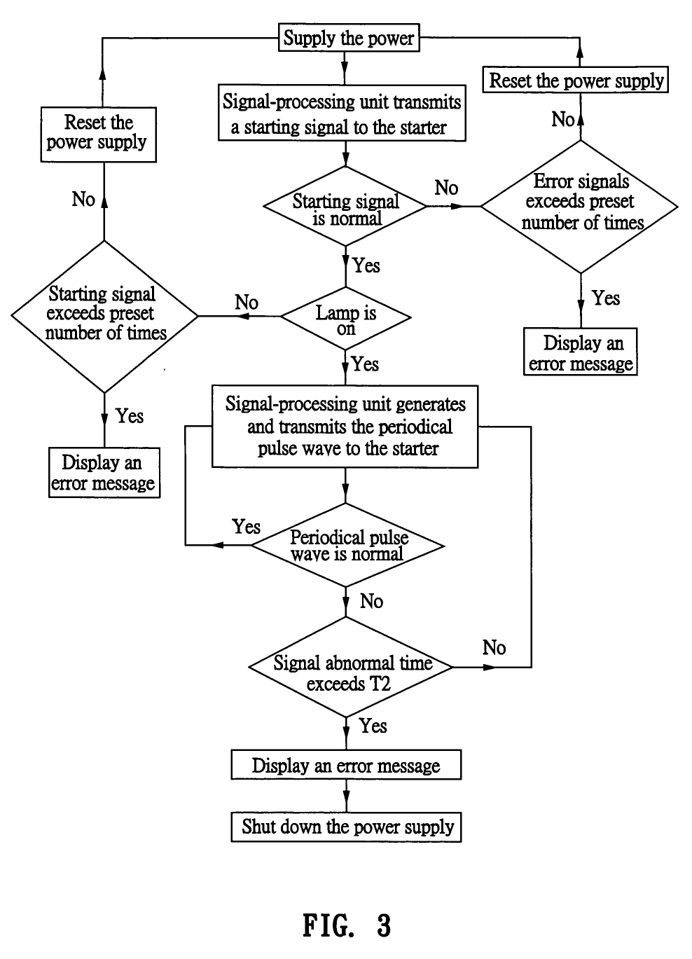

Please refer to FIG. 3. The power supply 21 is started first, and then the signal-processing unit 22 transmits the starting signal to the starter 24. The normal starting signal is a DC high voltage signal. Then the control unit 23 detects the starting signal on the connecting circuit between the signal-processing unit 22 and the starter 24. By detecting that there is a starting signal on the connecting circuit and it is a normal DC high voltage signal, the signal-processing unit 22 transmits a first detected signal to the control unit 23. However, if there is no starting signal detected on the connecting circuit or the detected signal is an abnormal starting signal such as pulsed wave, the signal-processing unit 22 transmits a second detected signal to the control unit 23. Then the control unit 23 uses the detected signal to control the power supply or monitor the “on” signal of the starter. When the detected signal is the first detected signal, the control unit 23 monitors the “on” signal of the starter, and when the detected signal is the second detected signal, the control unit determines if the error signals exceeds the preset number of times. If within the preset number of times, the control unit resets the power supply 21, but if it exceeds the preset number of times, the control unit controls the status display apparatus 26 to show the error signals in order to achieve the object of monitoring and protecting the lamp.

Then, the control unit 23 monitors the “on” signal of the starter by taking advantage of its timing and detecting function, including the following steps. By determining whether the control unit 23 receives the “on” signal sent out by the starter 24 at the first setup time (T1) or not, it is determined that if the lamp 25 is started at the first setup time (T1). If the starter 24 sends the “on” signal at the first setup time to the control unit 23 and the signal-processing unit 22, it represents that the lamp 25 is started and the control unit 23 will control the signal-processing unit 22 to generate and transmit the periodical pulse wave to the starter. On the other hand, when the lamp 25 is not started within the first setup time, the control unit 23 will count the starting times by the microcontroller to decide if it exceeds the preset times (for example: four times). If it reaches the preset times and the lamp 25 is not started, the control unit 23 displays the error massage to the status display apparatus 26. If it reaches the preset times and the lamp 25 is not started, the control unit 23 executes the power reset process in order to protect the lamp 25 and enter the control mode of the present invention.

Moreover, the signal-processing unit 22 controls the starter 24 according to the “on” signal. When the signal-processing unit 22 receives the “on” signal, the signal-processing unit generates and transmits the periodic pulse wave to the starter 24, on the other hand, if not received, the signal-processing unit 22 does not transmit the periodic pulse wave to the starter 24.

Thereafter, the control unit 23 detects the periodical pulse wave on the connecting circuit between the signal-processing unit 22 and the starter 24. When it detects that there is a periodical pulse wave on the connecting circuit, it transmits a third detected signal to the control unit 23. When it detects that there is no periodical pulse wave or the detected signal is not a periodical pulse wave on the connection circuit, it transmits a fourth detected signal to the control unit 23. The control unit 23 determines whether the periodical pulse wave is normal or not by the detected signal. When the detected signal is the third detected signal, then the periodical pulse wave is normal; on the other hand, when the detected signal is the fourth detected signal, then the periodical pulse wave is abnormal. When the detected signal is the third detected signal, the control unit 23 controls the signal-processing unit 22 continuously to generate and transmit the periodical pulse wave to the starter 24. When the detected signal is the fourth detected signal, the control unit 23 asks the signal-processing unit 22 to re-transmit the periodical wave and count the lasting time of the abnormal signal by the microcontroller disposed in the control unit 23. When the signal abnormal time exceeds the second preset time (T2), the error message is shown on the status display apparatus 26, and then a control signal is outputted by the control unit 23 in order to shut down the power supply 21. The present invention takes advantage of the control unit 23 to monitor and determine if the periodical pulse wave is normal or not, and when the periodical wave is abnormal the power supply is shut down in order to prevent the explosion of the lamp 25. This can increase the safety of the users.

Although the invention has been described in detail herein with reference to its preferred embodiment, it is to be understood that this description is by way of example only, and is not to be interpreted in a limiting sense. It is to be further understood that numerous changes in the details of the embodiments of the invention, and additional embodiments of the invention, will be apparent, and may be made by, persons of ordinary skill in the art having reference to this description. It is considered that such changes and additional embodiments are within the spirit and true scope of the invention as claimed below.

1. A method for monitoring signals of a projector, the projector comprising a power supply, a signal-processing unit, a control unit, a starter and a lamp, the method comprising the steps of:
turning on the power supply to supply the power needed by the projector;
the signal-processing unit sending a signal to the starter; and
the control unit monitoring the signal.

2. The method for monitoring signals of a projector according to claim 1, further comprising a status display apparatus connected to the control unit for displaying an error message of the projector.

3. The method for monitoring signals of a projector according to claim 1, wherein the signal is a starting signal.

4. The method for monitoring signals of a projector according to claim 3, wherein when the starting signal is normal, the control unit monitors whether the starter transmits an “on” signal to the control unit, and when the “on” signal is abnormal, the control unit continually monitors the starting signal within a preset number of times, and when the starting signal is within the preset number of times, the control unit resets the power supply, otherwise, when the starting signal exceeds the preset number of times, the control unit controls a status display apparatus to display an error message.

5. The method for monitoring signals of a projector according to claim 1, wherein the steps further comprising:
the starter sending an “on” signal to the control unit and the signal-processing unit;
the control unit and the signal-process unit determining whether the “on” signal is received;
the control unit controlling the power supply according to the “on” signal, the control unit monitoring a periodical pulse wave when the control unit receiving the “on” signal, the control unit continually monitoring the “on” signal within a preset number of times when the control unit not receiving the “on” signal, the control unit resetting the power supply when the detected number of times being within the preset number of times, the control unit controlling the status display apparatus to display an error message when the detected number of times being more than the preset number of times; and
the signal-processing unit controlling the starter according to the “on” signal, the signal-processing unit generating and transmitting the periodical pulse wave to the starter when the signal-processing unit receiving the starting signal, the signal-processing unit not transmitting the periodical pulse wave to the starter when the signal-processing not receiving the starting signal.

6. The method for monitoring signals of a projector according to claim 5, wherein when the periodical pulse wave is normal, the control unit controls the signal-processing unit to generate and transmit the periodical pulse wave to the starter, otherwise, the control unit counts the abnormal time of the periodical pulse wave, and when the abnormal time of the periodical pulse wave is within a preset time, the control unit controls the signal-processing unit to generate and transmit the periodical pulse wave to the starter, otherwise, the control unit controls the power supply to shut down the power and display an error message on the status display apparatus.

7. A apparatus for monitoring signals of a projector, comprising a power supply;
a signal-processing unit connected to the power supply for producing at least a signal;
a starter connected to the signal-processing unit to receive the signal and control a lamp according to the signal; and
a control unit connected to the power supply, the signal-processing unit and the starter to monitor and determine when the signal is normal for controlling the power supply and the signal-processing unit.

8. The apparatus for monitoring signals of a projector according to claim 7, wherein the signals include a starting signal and a periodical pulse wave.

9. The apparatus for monitoring signals of a projector according to claim 7, further comprising a status display apparatus.

10. The apparatus for monitoring signals of a projector according to claim 9, wherein the status display apparatus is a liquid crystal display panel.

11. The apparatus for monitoring signals of a projector according to claim 9, wherein the status display apparatus is a light emitting diode.

12. The apparatus for monitoring signals of a projector according to claim 7, wherein the starter transmits an “on” signal to the control unit and the signal-processing unit.
